(19) United States
(12) Patent Application Publication
(10) Pub. No.: US 2024/0284816 A1
(43) Pub. Date: Aug. 29, 2024

(54) COUPLING ARRANGEMENT FOR AN AGRICULTURAL TRACTOR

(71) Applicant: DEERE & COMPANY, MOLINE, IL (US)

(72) Inventors: CHRISTIAN ECKSTEIN, HEPPENHEIM (DE); MARTIN HEITLINGER, OESTRINGEN (DE); BENJAMIN SPOHN, HEILIGKREUTZSTEINACH (DE); MARIO PATINO, LUDWIGSHAFEN (DE)

(21) Appl. No.: 18/586,823

(22) Filed: Feb. 26, 2024

(30) Foreign Application Priority Data
Feb. 27, 2023 (DE) 102023104695.0

(51) Int. Cl. A01B 59/042; A01B 59/00

(52) U.S. Cl. CPC A01B 59/042; A01B 59/004; A01B 59/008

(57) ABSTRACT

A coupling arrangement for an agricultural tractor includes a drawbar having a first bar section, which is mounted in a longitudinally movable manner in a holder for attachment to an underside of a differential housing of the agricultural tractor, and a second bar section, which is situated opposite the first bar section and is guided in a longitudinally movable manner within adjacent upper and lower supporting cheeks of a coupling carrier plate provided for attachment to the rear of the agricultural tractor. The drawbar is movable into a plurality of coupling positions by longitudinal movement and can be locked therein with respect to the coupling carrier plate via at least one securing element.

### CROSS-REFERENCE TO RELATED APPLICATIONS

This application claims priority to German Patent Application No. 102023104695.0, filed Feb. 27, 2023, which is hereby incorporated by reference.

### FIELD OF THE DISCLOSURE

The disclosure relates to a coupling arrangement for an agricultural tractor, having a drawbar which can be moved lengthwise into various coupling positions and locked therein.

### BACKGROUND

A drawn implement can be coupled to a vehicle such as an agricultural tractor or utility vehicle with a drawbar which has an adjustable length.

### SUMMARY

A coupling arrangement includes a drawbar having a first bar section and a second bar section situated opposite the first bar section. The first bar section is mounted in a holder on the underside of a differential housing of the agricultural tractor and is fastened therein by means of a removable pin, which extends through a bore formed in the first bar section and is screwed to the differential housing. Furthermore, in the region of an end plate carrying a coupling ball, the second bar section has left and right threaded holes for receiving associated hexagonal bolts, by means of which the end plate is screwed to a coupling carrier plate provided in the rear region of the agricultural tractor. The drawbar can be mounted in one of two different coupling positions by releasing the pin and the two hexagonal bolts, thus enabling various operating situations of an attachment attached to the coupling ball to be taken into account. Owing to the design, the vertical forces occurring at the drawbar during operation of the attachment act directly on the screw connection produced by means of the two hexagonal bolts, and therefore correspondingly high tightening torques are required here. These have the effect that transfer of the drawbar between the two coupling positions is possible with a correspondingly high level of effort and is usually reserved for a workshop visit.

It is therefore the object of the present disclosure to optimize a coupling arrangement of the type stated at the outset with regard to convenient handling of a drawbar when changing between various coupling positions.

This object is achieved by a coupling arrangement for an agricultural tractor having the features of one or more of the following embodiments.

The coupling arrangement for an agricultural tractor comprises a drawbar having a first bar section, which is mounted in a longitudinally movable manner in a holder for attachment to an underside of a differential housing of the agricultural tractor, and a second bar section, which is situated opposite the first bar section and is guided in a longitudinally movable manner within adjacent upper and lower supporting checks of a coupling carrier plate provided for attachment to the rear of the agricultural tractor. The drawbar can be moved into a plurality of coupling positions by longitudinal movement and can be locked therein with respect to the coupling carrier plate via at least one securing element.

The guidance of the drawbar in the region of the second bar section by means of the two supporting cheeks or upper and lower sliding surfaces formed thereon ensures that the vertical forces occurring at the drawbar during operation of the attachment can be introduced directly into the coupling carrier plate. As a result, these are no longer associated with the actuating forces to be applied to the at least one securing element in order to lock the drawbar, and therefore these actuating forces can be optimized with regard to convenient handling of the drawbar when changing between its various coupling positions by appropriate selection or design of the at least one securing element.

Advantageous developments of the coupling arrangement according to the disclosure can be found in one or more of the following embodiments.

The at least one securing element has a threadless securing bolt, which can be passed through mutually aligned positioning openings, which are formed in the coupling carrier plate and the second bar section, in order to lock the drawbar, with the result that a longitudinal movement of the drawbar is reliably blocked. For this purpose, the positioning openings extend substantially perpendicularly to the longitudinal extent of the drawbar, wherein a plurality of positioning openings can be provided at intervals along the second bar section in accordance with a respective associated coupling position of the drawbar.

A circumferential collar can be formed on the securing bolt and, in the mounted state, rests against an upper side of the coupling carrier plate or an upper fastening eye projecting therefrom. A free end of the securing bolt emerges on an underside of the coupling carrier plate or a lower fastening eye projecting therefrom and is secured there against falling out, e.g. by means of a removable cotter pin. The securing bolt can be removed or reinserted manually and thus without tools to change the coupling position.

To enable the tensile forces occurring at the drawbar to be introduced as uniformly as possible into the coupling carrier plate during operation of an attachment, there is the possibility of providing left and right positioning openings for receiving a respective securing bolt on an end plate formed on the second bar section, wherein the positioning openings correspond to corresponding left and right positioning openings in the coupling carrier plate. The end plate typically has a beam-shaped profile transversely to the longitudinal extent of the drawbar, wherein the positioning openings are each situated at opposite left and right bar ends.

Furthermore, it is conceivable for the holder to have a guide element, which engages in a slotted hole in the first bar section, for limiting the extent of the longitudinal movement. The slotted hole allows the drawbar to be moved in a defined manner between the individual coupling positions after the at least one securing element has been released.

In this case, it is conceivable for the slotted hole to be open toward the free end of the first bar section. This makes it possible to pull the drawbar completely out of the holder after releasing the at least one securing element and, if necessary, to replace it with another. This is appropriate particularly when using drawbars fitted with different coupling elements.

In addition or as an alternative, it can be provided that left and right runners for reception in a rail system carrier of a tractor coupling system are formed on the coupling carrier plate. The rail system carrier is typically in the form of a trailer bracket mounted on a differential housing in the rear region of the agricultural tractor. The trailer bracket comprises left and right fixing rails, into which the runners of the coupling carrier plate can be inserted and locked. In addition, further coupling devices can be accommodated in the fixing rails in a height-adjustable manner, for example a coupling jaw mounted on a carrier slide.

The second bar section is passed in a drawer-like manner, at least along a permissible movement range, through an insertion opening that corresponds to its outer contour, and thus in a form-fitting manner within the coupling carrier plate. This ensures that the transverse forces occurring at the second bar section when the attachment is attached are reliably introduced into the surrounding coupling carrier plate in both the vertical and horizontal directions, with the result that essentially only the tensile forces or tensile force components acting on the drawbar in respect of its longitudinal extent act on the at least one securing element.

A coupling element, in the form of a ball head for example, can be attached to the second bar section. This is usually what is referred to as a K80 ball head, which is used to attach a complementary ball socket of an attachment coupling. In this case, the ball head can be mounted on the second bar section so as to be removable for the purposes of maintenance-related or wear-related exchange.

In one embodiment, the supporting cheeks are formed by the ends of the coupling carrier plate which adjoin the second bar section. In order to enlarge the contact area and thus the load-bearing capacity, the supporting cheeks can comprise guiding projections formed on the coupling carrier plate. As a structural extension of the upper and lower sliding surfaces formed by the two supporting cheeks, these are a one-piece component of the coupling carrier plate produced as a steel forging.

The above and other features will become apparent from the following detailed description and accompanying drawings.

### BRIEF DESCRIPTION OF THE DRAWINGS

The coupling arrangement according to the disclosure for an agricultural tractor will be described in more detail below with reference to the drawings. Here, identical reference signs relate to corresponding components or components which are comparable with respect to their function. In the drawings:

FIG. 1 shows a perspective view of one exemplary embodiment of the coupling arrangement according to the disclosure in the rear region of an agricultural tractor;

FIG. 2 shows a further perspective view of the coupling arrangement shown in FIG. 1;

FIG. 3 shows a side view of the coupling arrangement shown in FIG. 1 on a differential housing of the agricultural tractor;

FIG. 4 shows a lateral sectional view of the coupling arrangement shown in FIG. 3;

FIG. 5 shows a detail view of a holder for supporting a first bar section formed on a drawbar, which bar section is moved along a slotted hole into a first coupling position;

FIG. 6 shows the holder shown in FIG. 5, wherein the first bar section is moved along the slotted hole into a second coupling position;

FIG. 7 shows a variant of the drawbar in which the slotted hole is open toward the free end of the first bar section; and

FIG. 8 shows an insertion opening, formed within a coupling carrier plate of the coupling arrangement according to FIG. 1, for the longitudinally movable reception of a second bar section of the drawbar.

### DETAILED DESCRIPTION

The embodiments or implementations disclosed in the above drawings and the following detailed description are not intended to be exhaustive or to limit the present disclosure to these embodiments or implementations.

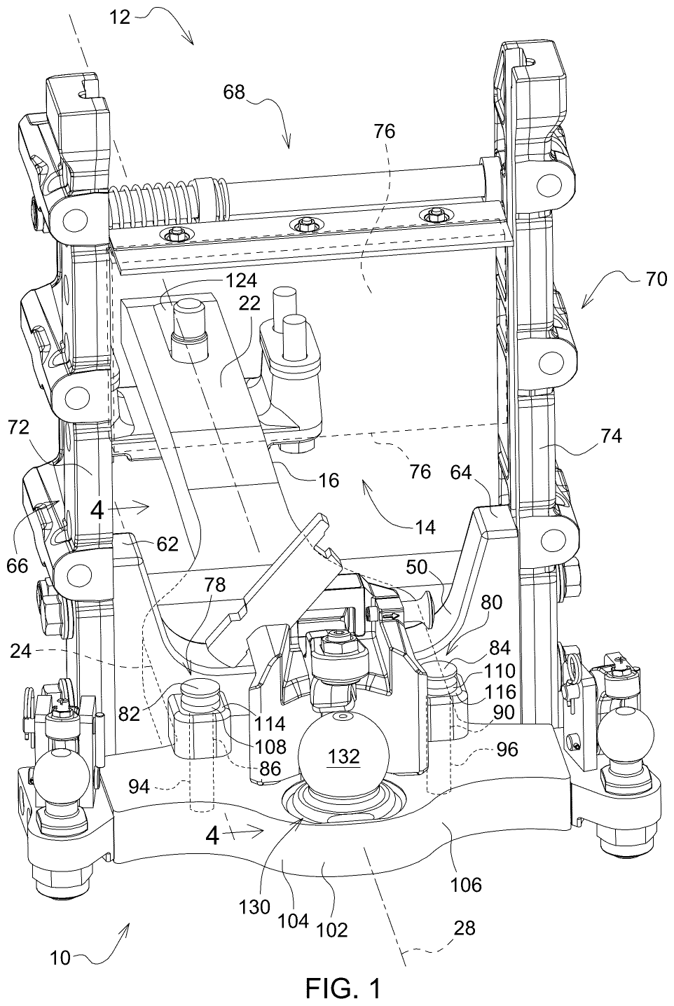

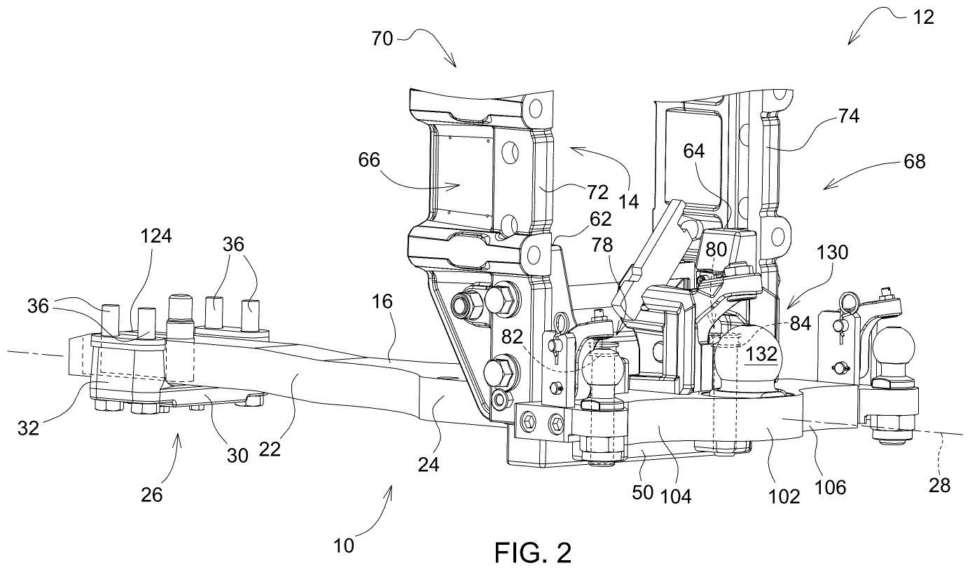

FIGS. 1 and 2 show various perspective complete views of one exemplary embodiment of the coupling arrangement 10 according to the disclosure for an agricultural tractor 12.

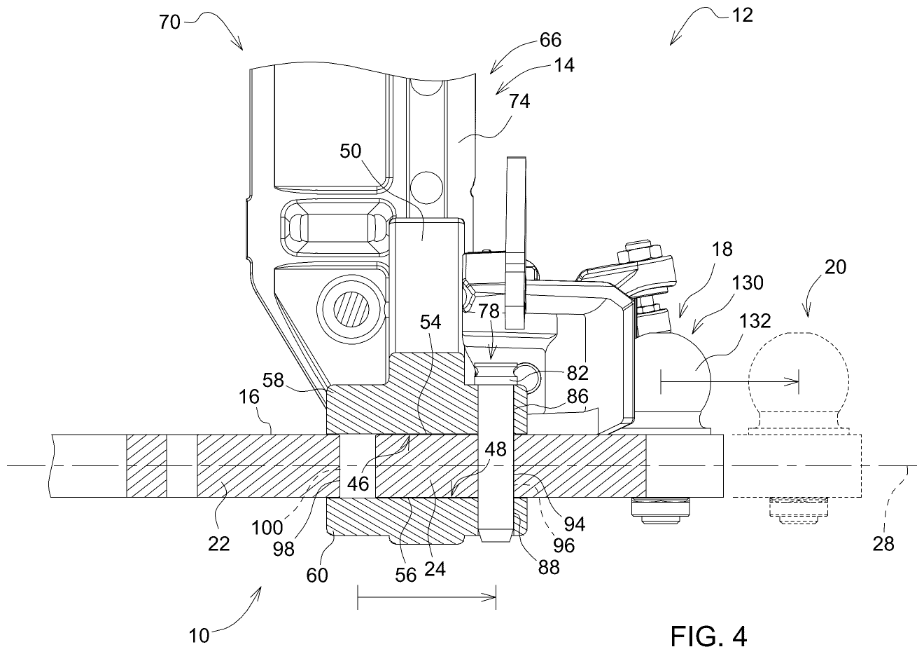

The coupling arrangement 10, which is situated in the rear region 14 of the agricultural tractor 12 (not illustrated specifically) comprises a drawbar 16 which can be moved lengthwise into various coupling positions 18, 20 and locked therein (see FIG. 4).

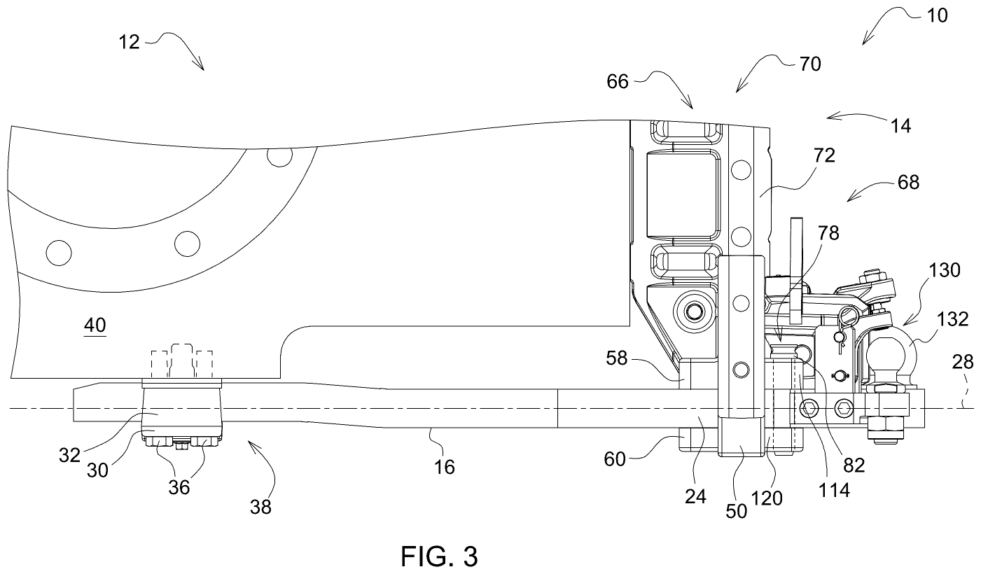

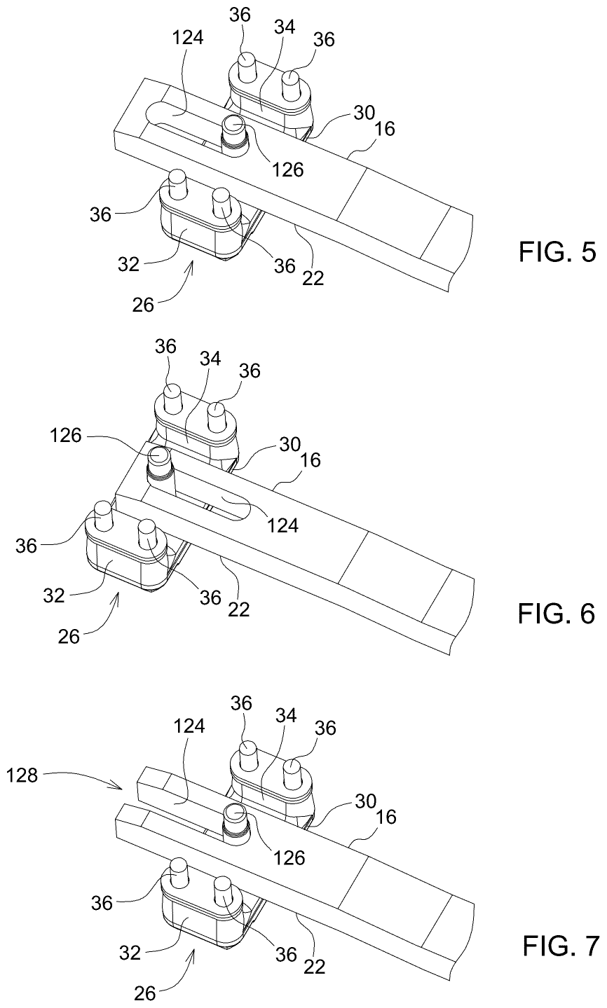

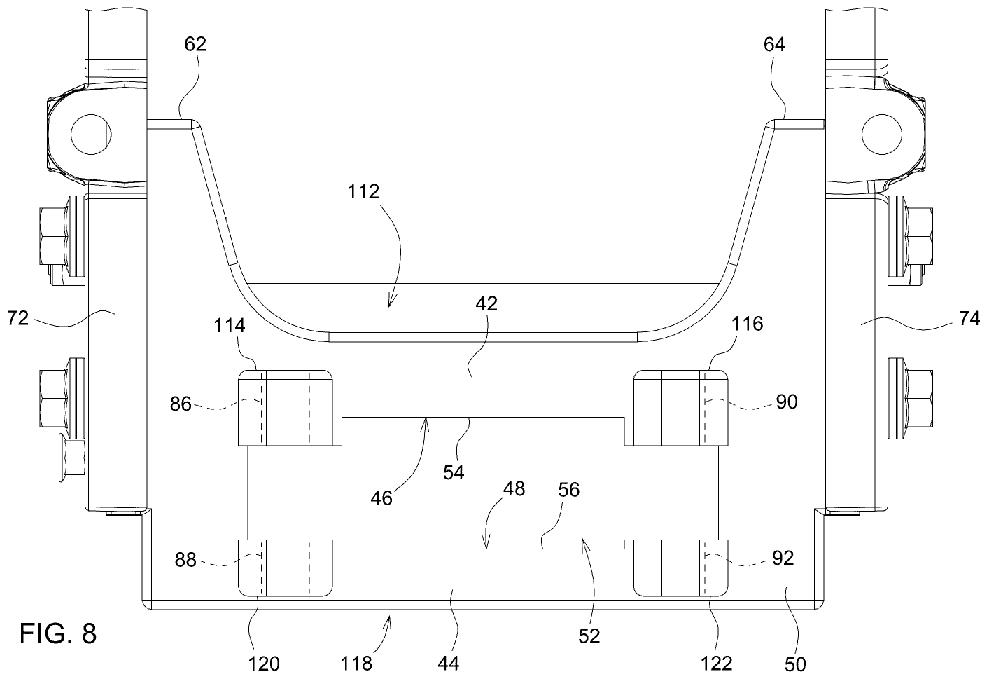

The drawbar 16, which has a tongue-shaped profile and is produced as a steel forging, has a first bar section 22 and a second bar section 24, which is situated opposite the first bar section 22. The first bar section 22 is mounted in a longitudinally movable manner in a box-shaped holder 26. As can be seen in FIG. 2 and the corresponding detail views in FIGS. 5 to 7, the box-shaped holder 26 includes a supporting plate 30, which extends transversely to the longitudinal extent 28 of the drawbar 16, extends between two mounting blocks 32, 34 and is mounted by means of a plurality of threaded bolts 36 on an underside 38 of a differential housing 40 of the agricultural tractor 12 (see FIG. 3). Furthermore, the second bar section 24 is guided in a longitudinally movable manner within adjacent upper and lower supporting checks 42, 44 or upper and lower sliding surfaces 46, 48 formed thereon (see FIG. 8) of a coupling carrier plate 50 provided for attachment to the rear of the agricultural tractor 12.

In one embodiment, the second bar section 24 is passed in a drawer-like manner, at least along a permissible movement range, through an insertion opening 52 that corresponds to its outer contour, and thus in a form-fitting manner within the coupling carrier plate 50. The profile of the insertion opening 52 is shown in FIG. 8 in a direction looking toward the rear region 14 of the agricultural tractor 12.

According to FIGS. 3 and 4, the supporting cheeks 42, 44 are formed, inter alia, by the ends 54, 56 of the coupling carrier plate 50, which adjoin the second bar section 24. In order to enlarge the contact area and thus the load-bearing capacity, the supporting cheeks 42, 44 comprise guiding projections 58, 60 formed on the coupling carrier plate 50. As a structural extension of the upper and lower sliding surfaces 46, 48 formed by the two supporting cheeks 42, 44, these are a one-piece component of the coupling carrier plate 50 produced as a steel forging.

Furthermore, left and right runners 62, 64 for reception in a rail system carrier 66 of a tractor coupling system 68 are formed on the coupling carrier plate 50. The rail system carrier 66 is in the form of a trailer bracket 72 mounted on a differential housing 40 in the rear region 14 of the agricultural tractor 12 (see FIGS. 1 and 2). The trailer bracket 72 comprises left and right fixing rails 72, 74, into which the runners 62, 64 of the coupling carrier plate 50 are inserted and locked. In addition, a further coupling device 76 (indicated in dashed lines) can be accommodated in the fixing rails 72, 74 in a height-adjustable manner, for example a coupling jaw mounted on a carrier slide.

As can be seen from the sectional view of the coupling arrangement 10 in FIG. 4, the drawbar 16 can be moved into one of the coupling positions 18, 20 by longitudinal movement and can be locked therein with respect to the coupling carrier plate 50 by means of associated securing elements 78, 80. According to the example, two coupling positions 18, 20 are provided, but there can also be any other number with a possibly different fixing hole pattern.

Each of the securing elements 78, 80 has a threadless securing bolt 82, 84, which can be passed through mutually aligned positioning openings 86, 88, 90, 92, 94, 96, 98, 100, which are formed in the coupling carrier plate 50 and the second bar section 24, in order to lock the drawbar 16, thus blocking a longitudinal movement of the drawbar 16 (see FIG. 4). For this purpose, the positioning openings 86, 88, 90, 92, 94, 96, 98, 100 extend substantially perpendicularly to the longitudinal extent 28 of the drawbar 16, wherein a plurality of positioning openings 94, 96, 98, 100 is provided at intervals along the second bar section 24 in accordance with a respective associated coupling position 18, 20 of the drawbar 16.

In one embodiment, there are left and right positioning openings 94, 96, 98, 100 for receiving a respective securing bolt 82, 84 on an end plate 102 formed on the second bar section 24, wherein the positioning openings correspond to corresponding left and right positioning openings 86, 88, 90, 92 in the coupling carrier plate 50. Only the left positioning openings 86, 88, 94, 96 can be seen in FIG. 4, and the right positioning openings 90, 92, 98, 100, which lie behind them in the viewing direction, are concealed in the selected view and are indicated by dashed reference lines.

The end plate 102 has a beam-shaped profile transversely to the longitudinal extent 28 of the drawbar 16, wherein the positioning openings 94, 96, 98, 100 are each situated at opposite left and right bar ends 104, 106.

A circumferential collar 108, 110 is formed on each of the securing bolts 82, 84 and, in the mounted state, rests against an upper side 112 of the coupling carrier plate 50 or upper left and right fastening eyes 114, 116 projecting therefrom (see FIGS. 1 and 8). A respective free end of the securing bolts 82, 84 emerges on an underside 118 of the coupling carrier plate 50 or lower left and right fastening eyes 120, 122 projecting therefrom and is secured there against falling out in each case by means of a removable cotter pin or the like (not shown). Each of the two securing bolts 82, 84 can be removed or reinserted manually and thus without tools to change the coupling position 18, 20.

According to FIGS. 5 and 6, the holder 26 has a guide element 126, which engages in a slotted hole 124 in the first bar section 22, for limiting the extent of the longitudinal movement. The slotted hole 124 allows the drawbar 16 to be moved in a defined manner between the first coupling position 18 (see FIG. 5) and the second coupling position 20 (see FIG. 6) after the two securing bolts 82, 84 have been released.

Based on the variant of the drawbar 16 shown in FIG. 7, the slotted hole 124 is open toward the free end 128 of the first bar section 22. This makes it possible to pull the drawbar 16 completely out of the holder 26 after releasing the securing bolts 82, 84 and, if necessary, to replace it with another. This is appropriate particularly when using drawbars 16 fitted with different coupling elements 130.

In accordance with the example, a coupling element 130 designed as a ball head 132 is attached to the second bar section 24 (see, inter alia, FIG. 1). In the present case, this is what is referred to as a K80 ball head, which is used to attach a complementary ball socket of an attachment coupling. The ball head 132 can be mounted on the second bar section 24 so as to be removable for the purposes of maintenance-related or wear-related exchange.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A coupling arrangement for an agricultural tractor, comprising:
a drawbar having a first bar section, which is mounted in a longitudinally movable manner in a holder for attachment to an underside of a differential housing of the agricultural tractor, and a second bar section, which is situated opposite the first bar section and is guided in a longitudinally movable manner within adjacent upper and lower supporting cheeks of a coupling carrier plate provided for attachment to the rear of the agricultural tractor;
wherein the drawbar is movable into a plurality of coupling positions by longitudinal movement and can be locked therein with respect to the coupling carrier plate via at least one securing element.

2. The coupling arrangement of claim 1, wherein the at least one securing element has a threadless securing bolt, which can be passed through mutually aligned positioning openings, which are formed in the coupling carrier plate and the second bar section, in order to lock the drawbar, with the result that a longitudinal movement of the drawbar is blocked.

3. The coupling arrangement of claim 2, wherein a circumferential collar is formed on the securing bolt and, in the mounted state, rests against an upper side of the coupling carrier plate or an upper fastening eye projecting therefrom.

4. The coupling arrangement of claim 2, wherein left and right positioning openings for receiving a respective securing bolt are provided on an end plate formed on the second bar section, wherein the positioning openings correspond to corresponding left and right positioning openings in the coupling carrier plate.

5. The coupling arrangement of claim 1, wherein the holder has a guide element, which engages in a slotted hole in the first bar section, for limiting the extent of the longitudinal movement.

6. The coupling arrangement of claim 5, wherein the slotted hole is open toward the free end of the first bar section.

7. The coupling arrangement of claim 1, wherein left and right runners for reception in a rail system carrier of a tractor coupling system are formed on the coupling carrier plate.

8. The coupling arrangement of claim 1, wherein the second bar section is passed in a drawer-like manner through an insertion opening, which corresponds to its outer contour, within the coupling carrier plate.

9. The coupling arrangement of claim 1, wherein a coupling element, in the form of a ball head for example, is attached to the second bar section.

10. The coupling arrangement of claim 1, wherein the supporting cheeks comprise guiding projections formed on the coupling carrier plate.
